(19) United States
(12) Patent Application Publication
(10) Pub. No.: US 2025/0340734 A1
(43) Pub. Date: Nov. 6, 2025

(54) MULTI-POLYMER COMPOSITIONS, FILMS, SHEETS AND THEIR APPLICATIONS THEREOF

(71) Applicant: Marc Ginsburg, Gloucester, MA (US)

(72) Inventor: Marc Ginsburg, Gloucester, MA (US)

(21) Appl. No.: 19/198,107

(22) Filed: May 4, 2025

Related U.S. Application Data
(60) Provisional application No. 63/641,873, filed on May 2, 2024.

(51) Int. Cl. C08L 67/02; A61C 7/08; C08J 5/18; C08L 75/04

(52) U.S. Cl. CPC C08L 67/02; A61C 7/08; C08J 5/18; C08L 75/04; C08J 2367/02; C08J 2375/04; C08J 2467/02; C08J 2475/04; C08L 2201/08; C08L 2203/02; C08L 2203/16; C08L 2203/30

(57) ABSTRACT

The present invention relates to multi-polymer compositions having desirable mechanical properties, optical properties, thermoformability, hydrophobicity, and biocompatibility. The present invention also relates to multi-polymer films, sheets, devices, appliances, or articles comprised of these multi-polymer compositions that have a range of applications in the dental and medical fields. The present invention also relates to manufacturing methodologies and modifications to manufacturing equipment used to make the multi-polymer compositions, films, sheets, devices, appliances, or articles. The compositions of the present invention can be blow molded, injection molded, or extruded, or the films or sheets comprising the compositions can be thermoformed to prepare a range of devices, appliances, or articles.

### BACKGROUND OF THE INVENTION

The present invention relates to multi-polymer compositions having desirable mechanical properties, optical properties, thermoformability, hydrophobicity, and biocompatibility (collectively, the “Core Properties”). The present invention also relates to multi-polymer films and sheets of multi-polymer material that exhibit desirable Core Properties which enable the films and sheets to have a range of applications in at least the dental and medical fields. The present invention also relates to manufacturing methodologies and modifications to manufacturing equipment to provide the manufacturing capability to make the multi-polymer compositions, films, and sheets. The compositions of the present invention can be blow molded, injection molded, or extruded, or the films or sheets comprising the compositions of the present invention can be thermoformed in order to be utilized in a wide range of applications, devices, and appliances.

Dental and medical appliances generally known in art are commonly made of single-polymer compositions that are typically limited by one or more of their Core Properties due to the inherent limitations of the single chosen polymer for use. These single-polymer compositions may be formed with or without additives such as antioxidants or UV-stabilizers that can provide slight improvements in one or more of the core properties or to one or more operational parameters of devices formed from the single-polymer compositions.

For dental appliances and devices such as orthodontic aligners and retainers, the most commonly utilized materials include single-polymer, single-layer polyethylene terephthalate glycol (polyethylene terephthalate (“PET”) that has been glycol-modified) or “PET-G” and single-polymer, single-layer thermoplastic polyurethane or “TPU.” PET-G and TPU materials are available in raw (e.g., pelletized) form in a range of grades that—due to differences for example in manufacturing methodologies and/or selection of additives in making the raw form of the material—result in differences in one or more of the Core Properties of the compositions, films, and sheets that are produced from each of the varying grades of the raw material. Additives which can be included in the various grades of raw form PET-G and TPU can include one or more of a wide-range of substances including, antioxidants, UV-stabilizers, plasticizers, and lubricants.

PET-G and TPU are commonly selected as a base material for a large number of dental and medical appliances at least because there are Food and Drug Administration (“FDA”) compliant grades available, and the materials often exhibit excellent thermoforming characteristics, are less brittle than many other materials, and can provide a high degree of transparency which is often particularly desirable in dental applications.

One issue, however, is that most raw form grades of PET-G and TPU, by themselves, cannot provide the complete balance of desirable Core Properties suitable for dental appliances and devices such as orthodontic aligners and retainers. For example, while PET-G materials manufactured from among the various raw form grades often provide, by themselves, a balance of some of the desirable Core Properties suitable for dental and medical applications, such as more desirable optical properties (higher light transmission and lower haze), hydrophobicity, and thermoformability (due to lower glass transition temperatures), the commonly fail to provide desirable mechanical properties that contribute to durability (e.g. impact strength and hardness). TPU materials, on the other hand, generally offer the more desirable mechanical properties that contribute to durability (e.g. impact strength and hardness) that PET-G materials fail to provide but often cannot provide the desired optical properties that PET-G can provide.

Attempts to overcome the unique deficiencies that each raw material provides (i.e., PET-G and TPU) in appliances and devices for both the dental and medical communities often result in multi-layer products that, for example, may include one or more layers of PET-G material combined with one or more layers of TPU material.

For example, some potential approaches to combining one or more grades of PET-G with one or more grades of TPU into a single material that can be used to manufacture dental and medical appliances and devices are accomplished by layering, in which one or more single-polymer layers of one type of polymer (i.e., PET-G or TPU) are added to one or more single-polymer layers of the other type of polymer (i.e., TPU or PET-G) to create a multilayer material.

Such approaches are well-known and have been described in numerous patents such as, for example, Li et al. U.S. Pat. No. 10,052,176 (describing “Multilayer Dental Appliances And Related Methods And Systems”), Li et al. U.S. Patent No. 9, 655, 691 (describing “Multilayer Dental Appliances And Related Methods And Systems”) (collectively, the “Li Patents”), and Stewart et al. Int. Pat. Pub. No. WO 2018/222864 (describing “Dual Shell Dental Appliance And Material Constructions”). Stewart, in particular, discloses a multi-layer sandwich in which two outer layers of a hard thermoplastic polymer are utilized to provide strength and stain resistance are layered on opposite sides of a soft elastomeric material that provides improved flexibility. The combined multi-layer sandwich can be formed into sheets which themselves can be manufactured into dental appliances that exhibit some of the positive properties of each of the different layered materials.

The Li Patents, on the other hand, disclose the opposite approach in which a layer of hard polymer material is sandwiched between two different layers of soft polymer material to form sheets of multi-layered material that can then be formed into dental appliances that again, exhibit some of the characteristics of each layer in the multi-layer sheets.

Thus, Stewart and Li both attempt to get the benefits from each of PET-G and TPU by disclosing multilayer materials and dental appliances composed thereof in which one or more of the individual layers may be formed from PET-G co-polyester combined with one or more individual layers formed from TPU polymers. The use of such multi-layer materials in the production of dental appliances and devices, such as in the manufacturing of orthodontic aligners, is widespread. For example, the Li Patents are currently assigned to the largest and premier provider of such devices, Align Technology. This widespread usage reflects the attempts to achieve an enhanced balance of some of the desirable Core Properties of these multi-layer materials as compared to that of devices formed from single-polymer materials, such as either PET-G or TPU.

Despite their ability to provide some enhanced balance of Core Properties, multi-layer materials have their own set disadvantages, such as being relatively expensive to manufacture as a result of the complex and fragile manufacturing procedures. Often small variations in the manufacturing process or in the base raw materials can result in deficiencies in the final sheet or product and the risk of delamination. In addition, the work required to extrude a multilayer material—extrusion is the current manufacturing methodology of choice because higher-volume users of these materials require them to be provided in roll format—is effectively a multiple of the work required to extrude a single-layer material.

To produce a multi-layer extruded material, for example, one must first extrude a number of single-layer materials and then bond the extruded materials together. This bonding step typically must be processed concurrent with the extrusion process of each layer of material, which requires more complex and expensive extrusion equipment and processing as well, at least because the temperatures, pressures, and timing tend to vary depending on the base material being extruded. The complexity of the manufacturing process makes it more expensive, resulting in less economical pricing for the finished, multi-layer materials, which is then passed on to patients or healthcare systems in the form of higher costs of the devices comprising these materials. The manufacturing complexity can also contribute to a lower consistency of the finished product. And because the multi-layer material includes independent layers of different polymers, there is a risk of these layers debonding (delaminating) over time, reducing the integrity or usability of devices made from these materials, particularly for longer-term use (e.g., for clear orthodontic retainers).

Given the potential issues related to the production of multi-layer sheets and manufacturing issues using those sheets to produce dental and medical appliances and devices, there has been some investigation into potentially compounding or otherwise mixing and blending PET-G and TPU into a single-layer, multi-polymer material instead of layering them individually into multilayer materials. If such a multi-polymer single-layer product could be developed, it should have the potential to provide more of the benefits of more of the desirable Core Properties without the disadvantages of significantly more complex and expensive manufacturing described above. In addition, if manufacturing of the dental and medical appliances and devices were accomplished using a single-layer material, there should be no risk of delamination (with only a single layer, there would be no possibility of multi-layers coming apart from each other). To date, however, research on such a single-layer material has concluded the opposite—that PET-G and TPU are generally considered to be incompatible for compounding or otherwise mixing and blending due to differences in each polymer's melting temperatures and melt flow rates. These differences can result in, for example, one polymer melting prior to the other or the two polymers melting at different rates, either of which prevent the two polymers from being combined into a single compound material that could then be formed into individual single layer sheets that could be used to manufacture and produce dental and medical appliances and devices.

Nonetheless, given the inherent downsides of utilizing multi-layer technology to manufacture and produce dental and medical appliances and devices, there is a strong need to overcome the inherent and natural incompatibility between PET-G and TPU materials from being formed into a compound or otherwise being mixed and blended to avoid the disadvantages of multilayer materials. By generating new materials—as well as devices and appliances composed of those materials—the resultant enhanced blends would provide improved desirable mechanical properties, optical properties, thermoformability, hydrophobicity, and biocompatibility for use in a range of applications in the dental and medical fields.

### SUMMARY OF THE INVENTION

The present invention overcomes the deficiencies of prior attempts to create, manufacture, and produce multi-polymer single layer compounds that can be processed into sheets or films, thermoformed, extruded, injection molded, blown molded and then manufactured and processed into dental and medical appliances and devices as described below.

Some embodiments relate to multi-polymer compositions comprising 0.1% to 50% by weight of thermoplastic polyurethane (TPU) and 25% to 99.9% by weight of polyethylene terephthalate glycol (PET-G), with or without additional polymers and/or additives such as antioxidants and/or UV-stabilizers which have been manufactured and produced as set forth herein in more detail. The multi-polymer compounds include varying percentages of both TPU and PET-G which result in material that may be formed into sheets or films, thermoformed, injection molded, and blown molded, and which may be manufactured and processed into dental and medical appliances and devices that exhibits an increased number of Core Properties, such as optical performance and desired flexibility and rigidity characteristics.

Accordingly, some embodiments result in single sheet multi-polymer material that relates to extruded or injection-molded multi-polymer films or sheets comprising 0.18 to 50% by weight of thermoplastic polyurethane (TPU) and 25% to 99.9% by weight of polyethylene terephthalate glycol (PET-G), with or without additional polymers and/or additives such as antioxidants and/or UV-stabilizers.

Other embodiments result in single sheet multi-polymer material that relates to extruded or injection-molded multi-polymer films or sheets comprising 0.1% to 20% by weight of thermoplastic polyurethane (TPU) and 80% to 99.9% by weight of polyethylene terephthalate glycol (PET-G), with or without additional polymers and/or additives such as antioxidants and/or UV-stabilizers. The variations in percentages may depend on a selection of Core Properties to emphasize based on the ultimate appliance, article, and/or product that is intended to be manufactured from the multi-polymer material. Other products may require even less of a percentage of TPU depending on the desired characteristics of the final product.

The extruded or injection-molded single-layer multi-polymer films or sheets may be thermoformed, and the single-layer films or sheets may have a thickness ranging from 300 microns to 1500 microns. As noted above, the extruded or injection-molded multi-polymer films or sheets exhibit excellent optical properties such that they are substantially clear, for example, exhibiting total light transmittance of greater than 75% while at the same time exhibiting haze of less than 20.0%. At the same time, such embodiments have proven to be quite flexible with a tensile stress at yield of 35 to 85 MPa and flexural modulus of elasticity of 1200 to 3500 MPa, while also exhibiting strong physical characteristics, for example, with a Shore D hardness of between 10 and 90 and IZOD impact strength of greater than 150 J/m. These embodiments all provide sufficient biocompatibility for a multitude of dental and/or medical uses.

In some embodiments, molded medical or dental appliances or articles may be produced through either injection molding or blow molding of multi-polymer materials comprising 0.1% to 50% by weight of thermoplastic polyurethane (TPU) and 25% to 99.9% by weight of polyethylene terephthalate glycol (PET-G), with or without additives such as antioxidants or UV-stabilizers. The molded medical or dental appliance or article may have a thickness in the range of 0.001 mm to 20 mm. These multi-polymer molded appliances or articles or tools or objects exhibit excellent optical qualities in that they are substantially clear demonstrating measurable total light transmittance at greater than 75% while also demonstrating haze at less than 2.0%. These appliances and articles also are highly flexible with demonstratable tensile stress at yields of between 35 to 85 MPa and flexural modulus of elasticity of between 1200 to 3500 MPa, while also exhibiting great strength with demonstrable Shore D hardness of between 10 and 90 and IZOD impact strength of greater than 250 J/m. In addition, these appliances and articles provide sufficient biocompatibility for a multitude of dental and/or medical uses.

Still other embodiments may result in single sheet multi-polymer material that can be injection molded or blow molded from multi-polymer compositions of 0.1% to 20% by weight of thermoplastic polyurethane (TPU) and 80% to 99.9% by weight of polyethylene terephthalate glycol (PET-G), with or without additional polymers and/or additives such as antioxidants and/or UV-stabilizers. The variations in percentages may depend on a selection of Core Properties to emphasize based on the ultimate appliance, article, and/or product that is intended to be manufactured from the multi-polymer material. Other products may require even less of a percentage of TPU depending on the desired characteristics of the final product.

Some embodiments disclosed herein accomplish producing a compound of multi-polymer PET-G/TPU material by first manufacturing a multi-polymer composition utilizing an initial compounding procedure with higher ratios of TPU to PET-G than will be utilizing in manufacturing the final composition. The initial compounding procedure is then followed by a procedure that mixes the initially compounded material with additional PET-G in a subsequent extrusion or molding procedure that results in the final, desired ratios between TPU and PET-G.

Some embodiments disclosed herein accomplish producing a compound of multi-polymer PET-G/TPU material by overcoming some of the issues that multi-layer materials can experience due to the different melting properties of PET-G as compared to TPU, such as melting temperatures and melting rates. Thus, in order to manufacture multi-polymer PET-G/TPU material it may be advantageous to select PET-G and TPU base materials that have somewhat complementary melting profiles, for example, melting temperatures that may be within approximately 5 degrees Celsius of each other. Such selections will enable the PET-G and TPU to both melt in a somewhat consistent manner which avoids one material or the other melting first and potentially burning while the other material is melted.

### DETAILED DESCRIPTION

The principles and advantages of the present invention can be more clearly understood from the following detailed description.

In order to provide full, clear, concise and exact terms to persons of ordinary skill in the art, the following terminology will be used in accordance with the definitions set forth below. Unless defined otherwise, all technical and scientific terms used herein have the same meaning as commonly understood by persons of ordinary skill in the art as they relate to the present disclosure. Although methods and materials similar or equivalent to those described herein can be used in the practice or testing of the present invention, the preferred methods and materials are described herein. As used herein, each of the following terms has the meaning associated with it in this specification. Specific and preferred values listed below for individual process parameters, substitutes, and ranges are for illustration only; they do not exclude other defined values or other values falling within the preferred defined ranges.

To that end, as used herein, the singular forms “a,” “an,” and “the” include plural reference unless the context clearly dictates otherwise.

The term “dental appliance” as used herein refers to any removable or fixed apparatus that can be positioned in or on a subject's teeth, gingiva, mandible or maxilla. These appliances encompass a wide variety of devices, including but not limited to orthodontic, prosthetic, retaining, snoring/airway, cosmetic, therapeutic, protective (e.g., mouth guards), and habit-modification devices etc.

The term “tensile stress” as used herein refers to the maximum stress that a material can withstand while being stretched or pulled before “yield” begins to occur, which is the point at which plastic materials undergoing elastic (reversible) deformation begin to experience plastic (non-reversible) deformation and/or break. Put another way, plastic materials can be designed such that they are capable of being bent, twisted, folded, etc., but that prior to yield, will return to their “natural” state (the state they were designed to maintain). Once yield occurs, however, then bent, twisted, or folded, portion fails to return to its “natural” state because the physical performance properties of the plastic, at least some portion of them, has been permanently comprised.

The term “shore hardness” as used herein is with reference to a measure of the resistance a material has to indentation. For example, athletes tend to remove mouth guards from their mouth when they are not actively engaged in play. In some instances, these athletes can be seen on TV chewing or biting on the guard when a portion of it is sticking out of their mouth sideways (somewhat perpendicular to the intended orientation fully in the mouth). “Shore hardness” in the resistance the mouth guard has to being, for example, punctured by an incisor or other tooth while being chewed on during down time away from the field of play.

The term “flexural modulus” as used herein is with reference to the overall rigidity of a material and/or resistance of the material to bending. For example, the ability of the mouthguard to maintain its intended shape and orientation such that it continues to protect the teeth of the individual wearing it.

The term “haze” as used herein is with reference to the optical properties of the material, and in particular, to the scattering of light by a film that can result in a cloudy appearance or poorer clarity of objects that are viewed through the film.

The term “light transmission” as used herein is also with reference to the optical properties of the material, and in particular, in this case to the amount of light that can successfully pass through glass and other types of materials. The amount of transmission of light is expressed through a calculated percentage of the light that can pass through the materials being tested (i.e., the lower the percentage, the less light is passing through the material).

The term “extrusion” as used herein is with reference to forming a film or a sheet of material using a screw-driven extrusion system in which molten material is formed into films or sheets by physically forcing the material to be extruded through a die opening which forms the shape of the extruded material.

The term “injection molding” as used herein in with reference to producing parts by injecting molten material into a mold.

The term “blow molding” is used herein with reference to forming hollow appliances or articles by blowing material into a cavity such that the material forms on the walls of the cavity to form the appliances or articles without being filled.

The term “thermoforming” as used herein is with reference to the manufacturing process by which a film or sheet of heated plastic is forced and stretched onto the surface of a mold to create parts.

The term “film” as used herein is with reference to one or more layers of the disclosed multi-polymer compositions having a thickness of less than or equal to 200 microns.

The term “sheet” as used herein is with reference to one or more layers of the disclosed multi-polymer compositions having thickness of more than 200 microns.

Embodiments of the present invention include multi-polymer compositions—as well as films, sheets, devices, and appliances comprised thereof—that include two base polymer: (i) polyethylene terephthalate glycol (PET-G); and (ii) thermoplastic polyurethane (TPU), with or without the inclusion of any additional polymers and/or additives such as antioxidants and/or UV-stabilizers.

The use of multiple polymers in the multi-polymer compositions helps to overcome the deficiencies of single and multi-layer materials such as relative weaknesses of single-polymer materials with regard to desirable mechanical properties, optical properties, thermoformability, hydrophobicity, and biocompatibility for a range of applications in the dental and medical fields. These products can include, for example, clear orthodontic aligners and retainers. And the incorporation of these multiple polymers together into single-layer multi-polymer compositions helps to minimize and avoid additional expenses, reduced consistency of quality, and tendency to delaminate that can often be experienced through the manufacturing and use of multilayer materials in which each layer is formed from a single polymer material.

In some embodiments, the present invention provides multi-polymer compositions comprising 0.1% to 50% by weight of thermoplastic polyurethane (TPU) and 25% to 99.9% by weight of polyethylene terephthalate glycol (PET-G) that can not only be formed into an extruded film or sheet but can also be molded into desired medical or dental appliances or articles using an injection molding or blow molding process, depending on the desired product (e.g., whether the desired product is generally hollow or not).

In other embodiments, the present invention provides multi-polymer compositions comprising 0.1% to 20% by weight of thermoplastic polyurethane (TPU) and 80% to 99.9% by weight of polyethylene terephthalate glycol (PET-G), with or without additional polymers and/or additives such as antioxidants and/or UV-stabilizers. The variations in percentages may depend on a selection of Core Properties to emphasize based on the ultimate appliance, article, and/or product that is intended to be manufactured from the multi-polymer material. Other appliances, articles, and/or products may require even less of a percentage of TPU depending on the desired characteristics of the final product.

In some embodiments, the compositions of the present invention can produce single-use or repeat-use extruded films or sheets (depending on the thickness) and injection or blow molded medical or dental appliances or articles, all with a greater portion of desired Core Properties than as compared to appliances and articles manufactured from single-polymer multi-layer materials.

The production of compositions of various embodiments of the multi-polymer materials of the present invention, enable films, sheets, devices, appliances, or articles incorporating those compositions to have excellent Core Properties. For example, one of the excellent core properties resulting from the use of multi-polymer material is optical properties that can be clear, transparent or colored with gloss or matt finishes. These optical properties can exhibit a total light transmittance of 50% to 93%, while maintaining a haze of 0.3% to 1.2% (which prevents unwanted clouding, etc.)

Other Core Properties provided by the multi-polymer materials enable appliances or articles having an overall thickness (for solid items or parts of items) or wall thickness (for hollow items or parts of items) on the order of 0.001 mm to 20 mm. Structurally (another Core Property), the use of multi-polymer material provides appliances or articles that can have a tensile stress at yield of 20 to 85 MPa, while also having a flexural modules of elasticity of 650 to 4500 MPa. Regarding overall strength (another Core Property), the multi-polymer material can provide products having a Shore hardness of A50 to D90, and/or an IZOD impact strength greater than 50 J/m.

The polymer polyethylene terephthalate glycol (PET-G) is widely available. For example, PET-G can be obtained commercially from a number of companies such as Eastman Chemical Company, Sky Chemicals, Selenis, etc. The polymer thermoplastic polyurethane (TPU) is also widely available. For example, TPU can be obtained commercially from a number of companies such as Covestro, Lubrizol, BASF, Great Eastern Resins (GRECO), etc.

In various embodiments of the present invention, it may be preferrable to select each of the PET-G and TPU grades for use in the multi-polymer compositions that are “virgin” material in that they contain 0% recycled polymers. It may also be advantageous to select PET-G and TPU materials that are free from lubricants, plasticizers, and additives, any of which could potentially reduce the biocompatibility and/or increase the toxicity of devices made from multi-polymer materials formed from base PET-G and TPU materials that are not “virgin” materials.

In some embodiments, the molded films, sheets, devices, appliances, or articles formed from multi-polymer materials can be manufactured by processes such as thermoforming, injection molding or blow molding using commercially available machines with variable tonnage pressures depending on the weight of the article and mold design. The molding temperature, however, can be preferably maintained to not exceed 250° C., because overheating the multi-polymer material may result in loss of desired properties in the final item. Accordingly, in accordance with some embodiments, injection molding temperatures can be maintained in the range of 140° C. to 250° C.

In some embodiments, various devices, appliances, or articles can be made from the multi-polymer compositions of the present invention, such as oral appliances including, without limitation, orthodontic aligners, orthodontic retainers, mouth guards, and the like.

Embodiments of the present invention thus relate to devices, appliances, or articles made from the multi-polymer compositions described here. Specific examples of articles that can be made from the multi-polymer compositions can include, but are not limited to, extruded or blow films, extruded or blow sheets, thermoformed appliances or articles and injection molded or blow molded appliances or articles. Specific examples of multi-polymer films or sheets can include thin films or sheets, monolayer or multilayer multi-polymer coextruded or blown films or sheets. The molded appliances and/or articles can be produced by thermoforming, extrusion blow molding, injection blow molding or injection stretch blow molding, blow film molding or any other extrusion process, depending on, for example, whether the interior of the product is intended to be hollow.

In other embodiments, the multi-polymer materials disclosed herein can be used to manufacture molded medical or dental appliances and/or articles such as an aspirator tip, a needle barrier/sheath combination, a local anesthetic (LA) plunger, a barrier sleeve for a aspirator, a barrier film to cover surgical trays, or an apron, a mixing spatula, an interdental brush, a micro brush, a sectional impression tray, a full arch impression tray, cheek retractor, a tongue retractor, etc. The use of multi-polymer material provides each of these representative medical and dental products with a broader range and better performance of Core Properties, such as the optical and physical properties described above. Conventional multi-layer single-polymer based products, on the other hand, result in trade-offs where one Core Property may be improved by sacrificing another.

For example, the molded medical or dental appliances or articles of the present invention formed from multi-polymer materials can be a barrier sleeve for handheld portable LED curing light, an intraoral camera sleeve, a bag to carry autoclave wipes or waste bags made by blow film process, at least because the multi-polymer materials disclosed herein provide greater flexibility and at the same time greater strength, while also being capable of providing excellent optical properties such as substantially clear materials with little to no haze. Other examples can include, for example, dental mixing trays that can be manufactured by thermoforming of multi-polymer sheet process.

Other potential appliances and articles in accordance with embodiments disclosed herein can include, for example, molded medical or dental appliances or articles such as surgical suction tips that can be made by extrusion processes, medical blister packs and/or blister packs for other instruments or devices which can be made by utilizing multi-polymer films or sheets in an extrusion process.

The molded appliances or articles formed from multi-polymer materials described herein can be manufactured into impression material mixing tips, pump bottle for moisturizing lotions, toothbrushes having handles made by injection molding processes, which can all be used in dental, engineering, medical non-ICU, cosmetic, pharmacy applications, to name some non-limiting applications.

Persons skilled in the art will appreciate that the present invention is not limited to only the embodiments described, and that features described in one embodiment may be used in a different embodiment. The present invention more generally involves the production of multi-polymer compositions as well as appliances and articles manufactured from those compositions.

Accordingly, the foregoing description of specific embodiments of the present invention has been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others, skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the scope of the present invention.

Persons skilled in the art will also appreciate that the apparatus and methods of the present invention may be implemented in other ways than those described herein. All such modifications are within the scope of the present invention, which is limited only by the claims that follow.

What is claimed is:

1. A multi-polymer composition comprising:
0.1% to 50% by weight of thermoplastic polyurethane (TPU); and
25% to 99.9% by weight of polyethylene terephthalate glycol (PET-G).

2. The composition of claim 1, wherein:
the percentage by weight of TPU is between 0.1% and 20%; and
the percentage by weight of PET-G is between 80% and 99.9%.

3. The composition of claim 1, further comprising:
one or more additional polymers, other than TPU and PET-G.

4. The composition of claim 1, further comprising:
one or more additives comprising antioxidants and UV-stabilizers.

5. An extruded multi-polymer material comprising:
0.1% to 50% by weight of thermoplastic polyurethane (TPU); and
25% to 99.9% by weight of polyethylene terephthalate glycol (PET-G),
wherein the TPU and PET-G are combined into a composition and the composition is extruded into a material that is a thermoformable monolayer film having a thickness of 300 microns to 1500 microns.

6. The extruded multi-polymer material of claim 5, wherein:
the percentage by weight of TPU is between 0.1% and 20%; and
the percentage by weight of PET-G is between 80% and 99.9%.

7. The extruded multi-polymer material of claim 5, wherein the extruded material is flexible having a tensile stress at yield of between 35 and 85 MPa and a flexural modulus of elasticity of between 1200 to 3500 MPa, and the extruded material is strong having a Shore D hardness of between 10 and 90 and an IZOD impact strength of greater than 150 J/m.

8. The extruded multi-polymer material of claim 5, wherein the extruded material is substantially clear or colored having a gloss or matt finish, and wherein the material exhibits a total light transmittance of greater than 75% and a haze of less than 15.0%.

9. The extruded multi-polymer material of claim 5, wherein material is substantially hazy or opaque, white or colored, and wherein the material exhibits a total light transmittance of less than or equal to 75%, and a haze of greater than or equal to 15.0%.

10. A device having medical/dental biocompatibility comprising:
0.1% to 50% by weight of thermoplastic polyurethane (TPU); and
25% to 99.9% by weight of polyethylene terephthalate glycol (PET-G),
wherein the TPU and PET-G are combined into a composition and the composition is extruded into a composition material, and the composition material is thermoformable multi-polymer monolayer film having a thickness of 300 microns to 1500 microns that is formed into the device.

11. A molded medical/dental device comprising:
0.1% to 50% by weight of thermoplastic polyurethane (TPU); and
25% to 99.9% by weight of polyethylene terephthalate glycol (PET-G);
wherein the TPU and PET-G are combined into a composition and the composition is molded into the medical/dental device such that the device has an overall thickness if solid of between 0.001 mm and 20 mm, and wall thickness if hollow of between 0.001 mm to 20 mm.

12. The molded device of claim 11, wherein the device has a tensile stress at yield of between 20 to 85 MPa, a flexural modulus of elasticity of between 650 to 4500 MPa, a Shore hardness of between A50 to D90, and an IZOD impact strength greater than 50 J/m.

13. The molded device of claim 11, wherein the device is clear or colored with a gloss or matt finish, the device having a total light transmittance of greater than 75% and a haze of less than 15.0%.

14. The molded device of claim 11, wherein the device is hazy or opaque, white or colored, the device having a total light transmittance less than or equal to 75% and haze greater than or equal to 15.0%.

15. The molded device of claim 11, wherein the device is manufactured through one process comprising:
a thermoformed process, an injection molded process;
and a blow molded process.

16. The molded device of claim 11, wherein the device comprises one of: an orthodontic aligner and a retainer.

17. The molded device of claim 11, wherein the device comprises one of: an aspirator tip, a needle barrier/sheath combination, a local anesthetic (LA) plunger, an apron, a mixing spatula, an interdental brush, a micro brush, a sectional impression tray, a full arch impression tray, cheek retractor, a tongue retractor, a bag to carry autoclave wipes or waste bags, dental mixing trays, surgical suction tips, blister packs, impression material mixing tips, pump bottle for moisturizing lotions, toothbrushes.

18. A method of manufacturing a multi-polymer composition material comprising:
selecting a ratio of by weight of an initial quantity of thermoplastic polyurethane (TPU) to an initial quantity of polyethylene terephthalate glycol (PET-G) in the compound higher than a final ratio of TPU to PET-G in the composition;
extruding the initial quantity of TPU and the initial quantity of PET-G simultaneously to form an initial extruded compound;
mixing the initial extruded compound with additional PET-G during a subsequent process to produce a multi-polymer device having a lower ratio by weight of TPU to PET-G than the initial extruded compound.

19. The method of claim 18, wherein mixing comprises:
mixing the initial extruded compound with additional PET-G during a subsequent extrusion process to produce a multi-polymer device having a lower ratio by weight of TPU to PET-G than the initial extruded compound.

20. The method of claim 18, wherein mixing comprises:
mixing the initial extruded compound with additional PET-G during a subsequent molding process to produce a multi-polymer device having a lower ratio by weight of TPU to PET-G than the initial extruded compound.
